(19) United States
(12) Patent Application Publication
(10) Pub. No.: US 2010/0312675 A1
(43) Pub. Date: Dec. 9, 2010

(54) Systems and Methods for Reporting Chargebacks

(76) Inventors: Gasan O. Awad, Tampa, FL (US); Maureen Daniels, Lawrenceville, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/477,321

(22) Filed: Jun. 3, 2009

(51) Int. Cl. G06Q 40/00; G06F 17/30; G06Q 10/00

(52) U.S. Cl. 705/30; 705/35; 707/E17.014; 707/E17.044

(57) ABSTRACT

Systems and methods for reporting a chargeback are provided. In this regard, a representative method, among others, includes retrieving customer transaction data related to a closed account, the customer transaction data including at least one of the following: transaction amount, transaction date, transaction identification number, credit rating and authorization date; determining whether any inconsistencies exist based on the retrieved customer transaction data; and responsive to determining that the customer transaction has inconsistencies, reporting a chargeback to an acquirer bank.

### TECHNICAL FIELD

The present disclosure relates to a chargeback, and more particularly, the disclosure relates to systems and methods for reporting a chargeback.

### BACKGROUND

Card issuing banks typically have credit card fraud, processing errors, and mistakes from merchants, resulting in a chargeback to an acquirer bank. The investigation for a chargeback is typically done manually where an agent reviews a dispute filed by the customer and determines whether the customer has a fraudulent or improper transaction on their card. The investigation can be time consuming and complicated for the agent.

### SUMMARY

Systems and methods for reporting a chargeback are provided. In this regard, a representative method, among others, includes retrieving customer transaction data related to a closed account, the customer transaction data including at least one of the following: transaction amount, transaction date, transaction identification number, credit rating and authorization date; determining whether any inconsistencies exist based on the retrieved customer transaction data; and responsive to determining that the customer transaction has inconsistencies, reporting a chargeback to an acquirer bank.

A representative system, among others, includes a chargeback manager having instructions stored in memory of a computing device. The instructions comprise logic to retrieve customer transaction data related to a closed account, the customer transaction data including at least one of the following: transaction amount, transaction date, transaction identification number, credit rating and authorization date; logic to determine whether any inconsistencies exist based on the retrieved customer transaction data; and logic to, responsive to determining that the customer transaction has inconsistencies, report a chargeback to an acquirer bank.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram that illustrates a system that reports a chargeback.

FIG. 2 is a block diagram that illustrates an embodiment of a chargeback management server, such as that shown in FIG. 1.

FIG. 3 is a high-level flow diagram that illustrates an embodiment of the architecture, functionality, and/or operation of the system, such as that shown in FIG. 1.

FIGS. 4A-B are flow diagrams of an embodiment of the architecture, functionality, and/or operation of a chargeback manager, such as that shown in FIG. 2, that facilitates the reporting of chargebacks.

### DETAILED DESCRIPTION

Exemplary systems are first discussed with reference to the figures. Although these systems are described in detail, they are provided for purposes of illustration only and various modifications are feasible. After the exemplary systems are described, examples of flow diagrams of the systems are provided to explain the manner in which chargeback is reported.

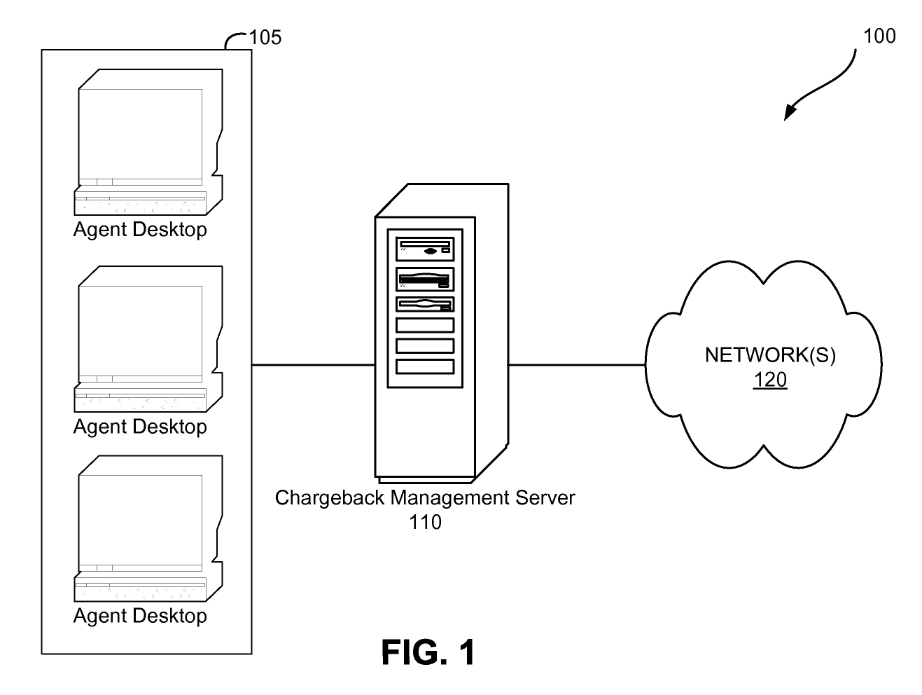

FIG. 1 is a block diagram that illustrates a system that reports a chargeback. The system 100 includes agent computing device(s) 105, network(s) 120 and chargeback management server 110. It should be appreciated that an agent can process a chargeback from the agent computing device 105 and view the chargeback before reversing a payment card transaction on behalf of the customer. Thus, agent and agent computing device 105 are used interchangeably in this disclosure.

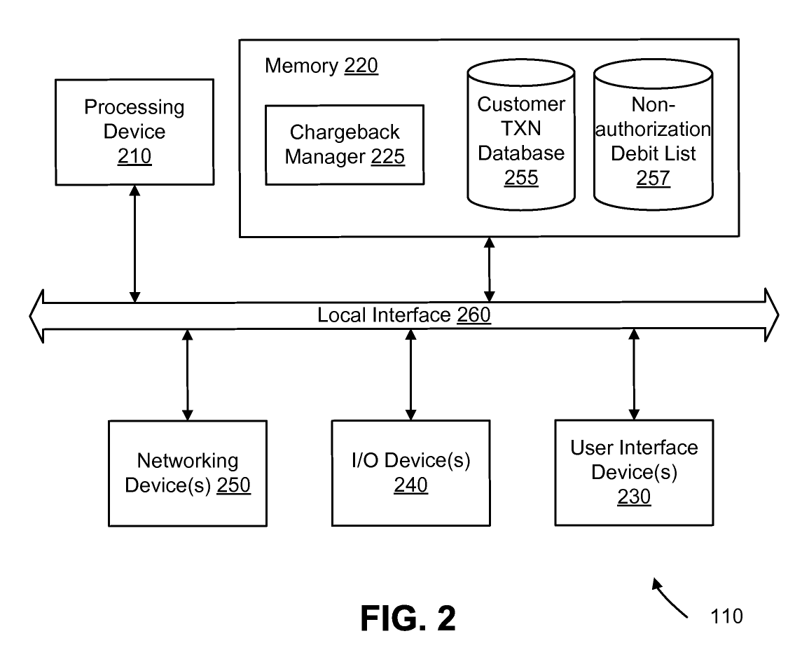

The agent computing device 105 are electrically connected to the chargeback management server 110, which is electrically connected to the network 120. Such network 120 can include one or more servers (not shown), intranet and internet. The chargeback management server 110 is further described in FIGS. 2-5.

FIG. 2 is a block diagram that illustrates an embodiment of a chargeback management server 110, such as that shown in FIG. 1. As indicated in FIG. 1, the chargeback management server 110 comprises a processing device 210, memory 220, one or more user interface devices 230, one or more I/O devices 240, and one or more networking devices 250, each of which is connected to a local interface 260.

The processing device 210 can include any custom made or commercially available processor, a central processing unit (CPU) or an auxiliary processor among several processors associated with the chargeback management server 110, a semiconductor based microprocessor (in the form of a microchip), or a macroprocessor. The memory 220 can include any one or a combination of volatile memory elements (e.g., random access memory (RAM, such as DRAM, SRAM, etc.)) and nonvolatile memory elements (e.g., ROM, hard drive, tape, CDROM, Flash Memory, etc.).

The one or more user interface devices 230 comprise those components with which the user (e.g., administrator) can interact with the chargeback management server 110. Where the computing components of the system 100 comprise server computers or similar devices, these components can comprise those typically used in conjunction with a PC such as a keyboard and mouse.

The one or more I/O devices 240 comprise components used to facilitate connection of the chargeback management server 110 to other devices and therefore, for instance, comprise one or more serial, parallel, small system interface (SCSI), universal serial bus (USB), or IEEE 1394 (e.g., Firewire™) connection elements. The networking devices 250 comprise the various components used to transmit and/or receive data over the network 120, where provided. By way of example, the networking devices 250 include a device that can communicate both inputs and outputs, for instance, a modulator/demodulator (e.g., modem), a radio frequency (RF) or infrared (IR) transceiver, a telephonic interface, a bridge, a router, as well as a network card, etc. For example, the networking devices 250 can facilitate sending chargeback information to an acquirer bank, such as Visa™ and MasterCard™.

The memory 220 of each computing components of the chargeback management server 110 comprises various programs (in software and/or firmware) including an operating system (O/S) (not shown), chargeback manager 225, customer transaction database 255, and non-authorization debit list 257. In general, the customer transaction database 255 includes data that is related to transactions made by a customer, e.g., transaction amount, transaction date, transaction identification number, and authorization date, among others. The non-authorization debit list 257 includes data related to closed accounts and their credit ratings.

The O/S controls the execution of programs, including the chargeback manager 225, and provides scheduling, input-output control, file and data management, memory management, and communication control and related services. The chargeback manager 225 facilitates determining inconsistencies of a customer transaction based on transaction amount, transaction date, transaction identification number, credit rating, and authorization. Operations of the chargeback manager 225 are further described in relation to FIGS. 2-5.

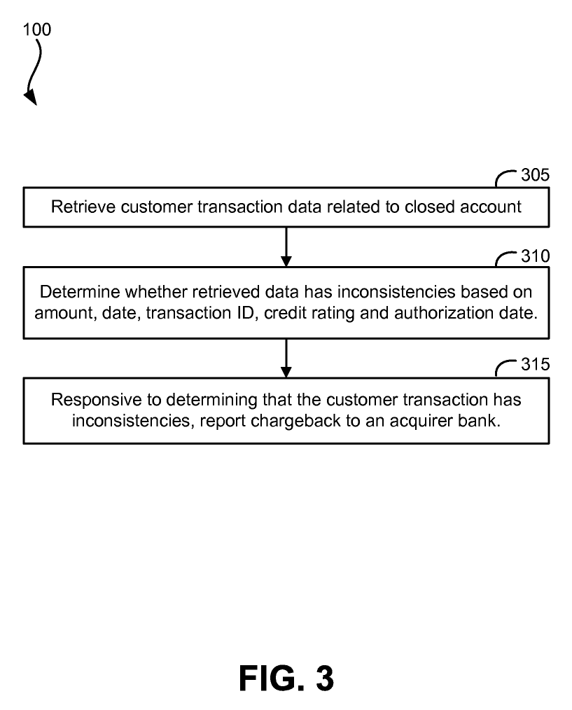

FIG. 3 is a high-level flow diagram that illustrates an embodiment of the architecture, functionality, and/or operation of the system 100, such as that shown in FIG. 1. In step 305, the system 100 retrieves customer transaction data that is related to closed accounts from the non-authorization debit list 257 (FIG. 2). The data may include transaction amount, transaction date, transaction identification number, credit rating and authorization date, among others. In step 310, the system 100 determines whether any inconsistencies exist based on the retrieved data. In step 315, responsive to determining that the customer transaction has inconsistencies, the system 100 reports a chargeback to an acquirer bank, e.g., Visa™ and MasterCard™.

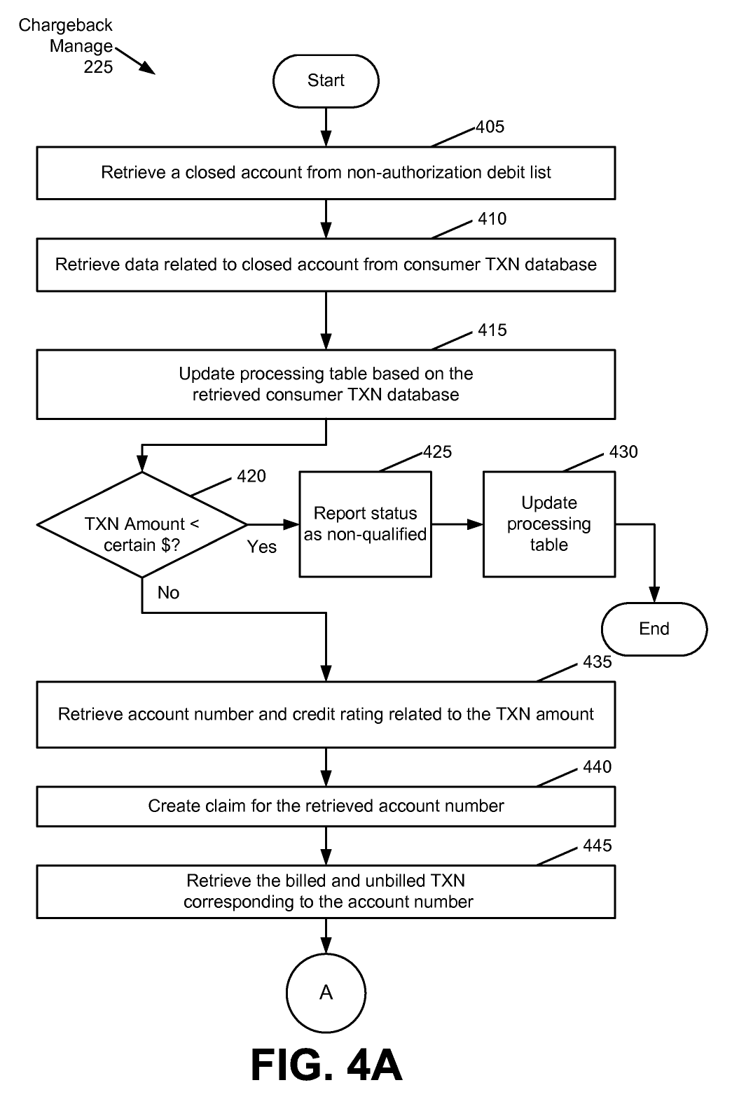

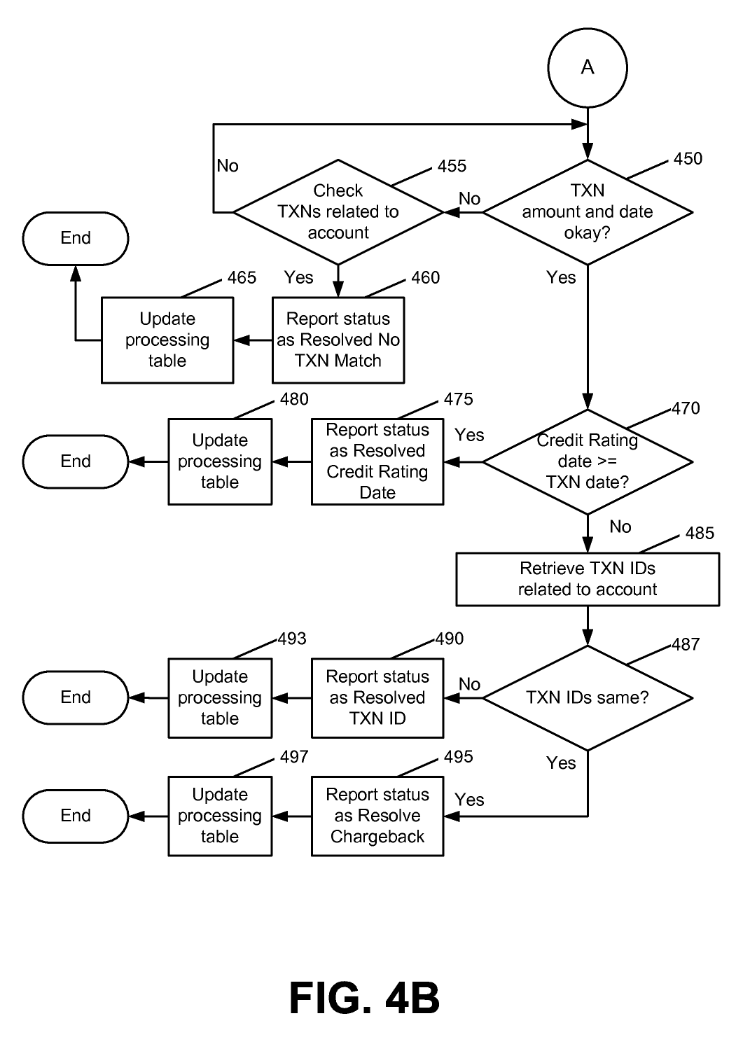

FIGS. 4A-B are flow diagrams of an embodiment of the architecture, functionality, and/or operation of a chargeback manager, such as that shown in FIG. 2, that facilitates the reporting of chargebacks. In steps 405 and 410, the chargeback manager 225 retrieves a closed account from the non-authorization debit list 257 (FIG. 2) and also retrieves customer transaction data related to the retrieved closed account from the customer transaction database 255 (FIG. 2). In step 415, the chargeback manager 225 updates a processing table based on the retrieved closed account and/or retrieved customer transaction data. The processing table includes information related to the chargeback processing activity related to the closed accounts as well as the transactions corresponding to the respective closed accounts. An administrative user can access and view the processing table to quickly determine whether the closed accounts have been processed for fraud or unauthorized charges that may result in a chargeback. The customer transaction data may include transaction amounts, transaction date, transaction identification number, customer credit rating, and charge authorization date.

In step 420, the chargeback manager 225 determines whether each of the transaction amounts of the closed account is greater than a certain dollar amount, e.g. $9.00. Responsive to determining that the transaction amount is less than a certain dollar amount, the chargeback manager 225 generates a report status as “non-qualified,” meaning that the transaction is not qualified for a chargeback, as shown in step 425. In step 430, the chargeback manager 225 updates the processing table to indicate that the transaction is not qualified for a chargeback. In step 435, responsive to determining that the transaction amount is greater than a certain dollar amount, the chargeback manager 225 retrieves an account number and credit rating from the closed account related to the transaction amount. In step 440, the chargeback manager 225 creates a claim for the retrieved account number. The claim is stored in the system 100, allowing an administrative user to determine that the account number has a transaction amount greater than a certain dollar amount.

In step 445, the chargeback manager 225 retrieves billed and unbilled transactions corresponding to the account number. In step 450, the chargeback manager 225 determines whether the transaction amount and date of the retrieved billed and unbilled transactions from the customer transaction database matches the transaction amount and date from the non-authorization debit list 257. In step 455, the chargeback manager 225 checks every transaction amount and date from the customer transaction database associated with the closed account with the transaction amount and date from the non-authorization debit list 257. Responsive to determining that every transaction amount and date from the customer transaction database associated with the closed account does not match with the transaction amount and date associated with the closed account from the non-authorization debit list 257, the chargeback manager 225 generates a report status as “Resolved no transaction match” and updates the processing table to indicate the status, as shown in steps 460 and 465, respectively.

Responsive to determining that the transaction amount and date from the customer transaction database match the transaction amount and date from the non-authorization debit list 257, the chargeback manager 225, in step 470, determines whether the date of the credit rating from the non-authorization debit list 257 is later or matches the date of the transaction date. It should be noted that the date of the credit rating from the non-authorization credit list 257 indicates that the account is closed at that date. Thus, if the transaction occurred later than the date of the credit rating, the chargeback manager 225, in step 485, retrieves the transaction identification number related to the transaction amount and date of the closed account. Responsive to determining that the transaction occurred before or at the date of the credit rating, the chargeback manager 225, in steps 475 and 480, generates a report status as “Resolved Credit Rating date,” and updates the processing table to reflect the current status.

In step 487, the chargeback manager 225 determines whether the transaction identification number associated with the transaction amount and date of the closed account from the customer transaction database 255 matches the transaction identification number associated with the transaction amount and date from the non-authorization debit list 257. Step 487 checks whether the transaction identification number correctly corresponds with the transaction amount and date of the closed account based on the non-authorization debit list 257. Responsive to determining that there is no match of the transaction identification number, the chargeback manager 225, in steps 490 and 493, generates a report status as “Resolved Transaction ID,” and updates the processing table to reflect the status. Responsive to determining that there is a match of the transaction identification number, the chargeback manager 225, in steps 495 and 497, generates a report status as “Resolved Chargeback,” indicating that a chargeback of the transaction amount should occur from the card issuing bank to the acquirer bank, and updates the processing table to reflect the current status. For example, the debit related to the transaction identification number is transferred from the card issuing bank to the acquirer bank. Alternatively or additionally, the chargeback manager 225 can send information using a networking device 250 (FIG. 2) to the acquirer banks, e.g., Visa™ and MasterCard™, to transfer the debit from the card issuing bank to the acquirer bank.

It should be noted that any process descriptions or blocks in flowcharts should be understood as representing modules, segments, or portions of code which include one or more executable instructions for implementing specific logical functions or steps in the process. As would be understood by those of ordinary skill in the art of the software development, alternate embodiments are also included within the scope of the disclosure. In these alternate embodiments, functions may be executed out of order from that shown or discussed, including substantially concurrently or in reverse order, depending on the functionality involved.

This description has been presented for purposes of illustration and description. It is not intended to be exhaustive or to limit the disclosure to the precise forms disclosed. Obvious modifications or variations are possible in light of the above teachings. The embodiments discussed, however, were chosen to illustrate the principles of the disclosure, and its practical application. The disclosure is thus intended to enable one of ordinary skill in the art to use the disclosure, in various embodiments and with various modifications, as is suited to the particular use contemplated. All such modifications and variation are within the scope of this disclosure, as determined by the appended claims when interpreted in accordance with the breadth to which they are fairly and legally entitled.

What is claimed:

1. A method for reporting a chargeback, the method comprising:
retrieving, at a specific computer, customer transaction data related to a closed account, the customer transaction data including at least one of the following: transaction amount, transaction date, transaction identification number, credit rating and authorization date;
determining whether any inconsistencies exist based on the retrieved customer transaction data; and
responsive to determining that the customer transaction has inconsistencies, reporting a chargeback to an acquirer bank.

2. The method as defined in claim 1, further comprising determining whether each of the transaction amounts of the closed account is greater than a certain dollar amount.

3. The method as defined in claim 2, further comprising responsive to determining that the transaction amount is greater than the certain dollar amount, retrieving an account number and credit rating from the closed account related to the transaction amount.

4. The method as defined in claim 3, further comprising retrieving billed and unbilled transactions corresponding to the account number.

5. The method as defined in claim 4, further comprising determining whether the transaction amount and date of the retrieved billed and unbilled transactions from a customer transaction database matches the transaction amount and date from a non-authorization debit list, the customer transaction database including data that is related to transactions made by a customer and the non-authorization debit list including data related to closed accounts and their credit ratings.

6. The method as defined in claim 5, further comprising responsive to determining that the transaction amount and date from the customer transaction database match the transaction amount and date from the non-authorization debit list, determining whether the date of the credit rating from the non-authorization debit list is later or matches the date of the transaction date.

7. The method as defined in claim 6, further comprising, if the transaction occurred later than the date of the credit rating, retrieving a transaction identification number related to the transaction amount and date of the closed account.

8. The method as defined in claim 7, further comprising determining whether the transaction identification number associated with the transaction amount and date of the closed account from the customer transaction database matches the transaction identification number associated with the transaction amount and date from the non-authorization debit list.

9. The method as defined in claim 8, further comprising responsive to determining that there is a match of the transaction identification number, generating a report status indicating that a chargeback of the transaction amount should occur from the card issuing bank to the acquirer bank.

10. A system that is configured to report a chargeback, the system comprising:
a chargeback manager having instructions stored in memory of a computing device, the instructions comprising:
logic to retrieve customer transaction data related to a closed account, the customer transaction data including at least one of the following: transaction amount, transaction date, transaction identification number, credit rating and authorization date;
logic to determine whether any inconsistencies exist based on the retrieved customer transaction data; and
responsive to determining that the customer transaction has inconsistencies, logic to report a chargeback to an acquirer bank.

11. The system as defined in claim 10, further comprising logic to determine whether each of the transaction amounts of the closed account is greater than a certain dollar amount.

12. The system as defined in claim 11, further comprising responsive to determining that the transaction amount is greater than a certain dollar amount, logic to retrieve an account number and credit rating from the closed account related to the transaction amount.

13. The system as defined in claim 12, further comprising:
logic to retrieve billed and unbilled transactions corresponding to the account number; and
logic to determine whether the transaction amount and date of the retrieved billed and unbilled transactions from a customer transaction database matches the transaction amount and date from a non-authorization debit list, the customer transaction database including data that is related to transactions made by a customer and the non-authorization debit list including data related to closed accounts and their credit ratings.

14. The system as defined in claim 13, further comprising responsive to determining that the transaction amount and date from the customer transaction database match the transaction amount and date from the non-authorization debit list, logic to determine whether the date of the credit rating from the non-authorization debit list is later or matches the date of the transaction date.

15. The system as defined in claim 14, further comprising:
if the transaction occurred later than the date of the credit rating, logic to retrieve a transaction identification number related to the transaction amount and date of the closed account; and
logic to determine whether the transaction identification number associated with the transaction amount and date of the closed account from the customer transaction database matches the transaction identification number associated with the transaction amount and date from the non-authorization debit list.

16. The system as defined in claim 15, further comprising responsive to determining that there is a match of the transaction identification number, logic to generate a report status indicating that a chargeback of the transaction amount should occur from the card issuing bank to the acquirer bank.

17. A chargeback manager that is configured to report a chargeback, the chargeback manager having instructions stored in memory of a computing device, the instructions comprising:
logic to retrieve customer transaction data related to a closed account, the customer transaction data including at least one of the following: transaction amount, transaction date, transaction identification number, credit rating and authorization date;
logic to determine whether any inconsistencies exist based on the retrieved customer transaction data; and
responsive to determining that the customer transaction has inconsistencies,
logic to report a chargeback to an acquirer bank.

18. The chargeback manager as defined in claim 17, further comprising:
logic to determine whether each of the transaction amounts of the closed account is greater than a certain dollar amount; and
responsive to determining that the transaction amount is greater than a certain dollar amount, logic to retrieve an account number and credit rating from the closed account related to the transaction amount.

19. The chargeback manager as defined in claim 18, further comprising:
logic to retrieve billed and unbilled transactions corresponding to the account number and determine whether the transaction amount and date of the retrieved billed and unbilled transactions from a customer transaction database matches the transaction amount and date from a non-authorization debit list, the customer transaction database including data that is related to transactions made by a customer and the non-authorization debit list including data related to closed accounts and their credit ratings; and
logic to responsive to determining that the transaction amount and date from the customer transaction database match the transaction amount and date from the non-authorization debit list, determine whether the date of the credit rating from the non-authorization debit list is later or matches the date of the transaction date.

20. The chargeback manager as defined in claim 19, further comprising:
if the transaction occurred later than the date of the credit rating, logic to retrieve a transaction identification number related to the transaction amount and date of the closed account;
logic to determine whether the transaction identification number associated with the transaction amount and date of the closed account from the customer transaction database matches the transaction identification number associated with the transaction amount and date from the non-authorization debit list; and
responsive to determining that there is a match of the transaction identification number, logic to generate a report status indicating that a chargeback of the transaction amount should occur from the card issuing bank to the acquirer bank.
